(19) United States
(12) Patent Application Publication
(10) Pub. No.: US 2022/0398922 A1
(43) Pub. Date: Dec. 15, 2022

(54) ADAPTIVE TRAFFIC LIGHT SYSTEM FOR REDUCING CITY TRAFFIC

(71) Applicant: Andrea SERRAVEZZA, ROMA (RM) (IT)

(72) Inventor: Andrea SERRAVEZZA, ROMA (RM) (IT)

(21) Appl. No.: 17/775,189

(22) PCT Filed: Oct. 29, 2020
(86) PCT No.: PCT/IB2020/060133

§ 371 Date: May 6, 2022

(30) Foreign Application Priority Data
Nov. 7, 2019 (IT) 102019000020544

(51) Int. Cl. G08G 1/081; G08G 1/087

(52) U.S. Cl. CPC G08G 1/081; G08G 1/087

(57) ABSTRACT

Adaptive traffic light system for reducing city traffic, consisting of several interconnected modules; the user specifies the departure and destination of his/her route on an application executable on a smartphone, or on an ad-hoc hardware device, which carries out the functions of a navigator; the application sends the arrival and departure point to a central unit which returns the best path in terms of time, length, traffic and with the lowest wait time at the traffic light devices that receive the commands on setting the lights to minimize the users travel time; the device communicates with the traffic lights the crossing at the intersection which together with the data provided by the application on the speed and position are used by the central unit to update the route and the commands to be sent to the next traffic lights;

This application is the U.S. national phase of International Application No. PCT/IB2020/060133 filed Oct. 29, 2020 which designated the U.S. and claims priority to IT 102019000020544 filed Nov. 7, 2019, the entire contents of each of which are hereby incorporated by reference.

### BACKGROUND OF THE INVENTION

### Field of the Invention

The present invention relates to the field of adaptive traffic light systems. In particular, the subject invention aims to provide a traffic light system capable of managing user requests in order to reduce their waiting times and reduce city traffic.

### Description of the Related Art

Today, traffic congestion in the city is a difficult problem to solve. The large crowding of cities and the substantial use of private means of transport such as cars create numerous inconveniences such as: environmental pollution, dead times due to heavy traffic and therefore to the efficiency of the means of transport, waste of fuel due to means of transport in queue and the impossibility of a sudden response of the emergency vehicles in case of emergency. The pollution is caused both by the large number of cars in circulation and, in case of traffic, by the engines running when the cars cannot travel. This results in a clear waste of fuel, and therefore economic expenditure for road users. In fact, every minute of the engine running and not traveling is a waste of money. The start & stop mode introduced on newer cars partly helps to solve this problem. However it is ineffective in the case of queues where one proceeds at walking pace, consequently it cannot be used. In fact, in such situations the cars do not reach the parking condition, and if it is reached the car persists in this state only for brief moments, and then continues for a few meters and in case it stops again. This results in a large amount of time wasted due to waiting, largely due to traffic light stops for managing intersections. Many times these stops are unnecessary. Think of the numerous situations, especially in which the traffic is minimal or completely absent, in which one is forced to wait for the green at the traffic lights even at a desert intersection. Traffic congestion has a further negative effect, such as blocking vehicles destined for emergencies. Traffic represents a strong barrier on the way of emergency vehicles such as ambulances, police forces and emergency services. This does not allow arriving quickly at the intervention site, sometimes causing the loss of human life due to late rescue.

In this scenario, traffic light systems play a fundamental role, being responsible for controlling the traffic within urban centers. The latter, despite the technological advances of recent years in the field of electronic devices and communications, have not yet reached the level of sophistication that would allow them to be adaptive based on the needs of individuals.

In the international field it is possible to find a good number of patent inventions concerning the scope and the need described, such as the Chinese patent CN206497566

which proposes a system based on cameras that monitor the vehicles present at the intersection to ensure optimal flow of traffic. However, this system is highly localized and is able to manage only one intersection at a time, ignoring the complex interactions of a city network where traffic lights follow one another very frequently. The patent CN207947768 instead describes different communication protocols between traffic lights positioned at different intersections and the central system. The patents CN208315007 and CN205609020 propose systems to create “green waves”, the first based on the use of cameras positioned above the traffic lights, the second through a centralized system capable of receiving information from the on-board computers of the cars, calculating the solution of the problem that guarantees a green wave, and sending it to traffic lights.

Despite the availability of such solutions, however, it is clear that the problems described above are only partly resolved, without fully addressing the critical issues highlighted.

### SUMMARY OF THE INVENTION

According to the present invention, a system is provided and a method is described for providing a traffic light system capable of managing user requests in order to reduce their waiting times and reduce city traffic.

The implementation of this system requires both hardware and software components, therefore it is to be considered as a specific project drawn up with the support of the public offices in charge of traffic management, with their consent and collaboration. This would allow the installation of a control device connected to the central system for each single traffic light system and which monitors, controls and ascertains the actual passage of the car. This central system, heart and brain of the project.

The invention may be divided into 4 main components. The first is a traffic light system, which placed at an intersection performs the function of regulating the flow of traffic. Advantageously with this classic embodiment, the traffic light performs the function of regulating the flow in a classical manner, on a timed basis or in an adaptive manner by implementing the commands sent by a central control unit. For this purpose, the device is provided with a wireless and/or wired internet connection. The traffic light has another communication network of the wan type which allows communicating with a device installed on the cars and checking the actual passage of the vehicle at the intersection and communicating it accordingly to the central system. The device installed on the vehicle is another fundamental component of the application. It is a simple box which, through the wan protocol, allows the identification of the oncoming vehicle, in fact each box is associated with a user, and with the actual passage of the same at the intersection. This allows having updated and granular information on each user. The information collected as already mentioned is sent to the central unit. This third fundamental component of the proposed invention plays a critical role. In fact, it receives requests from all users regarding departure and destination. After collecting the requests, the system predicts the best route in real time, estimating travel times with a predictive model, and validating the model at each intersection crossed, it will calculate the commands relating to traffic management to the traffic light units in order to reduce waiting at traffic lights. The system is able to improve over time thanks to the increasing input with the use of data. The user can interact and use this service through an application that can be run on a smartphone. Through the application, one can in fact choose the starting point and the destination. These data will be sent to the central unit which will calculate the optimal route and optimize the time intervals of the traffic lights so that the user waits as little as possible without moving. If the device is provided with GPS, this information will be used to update and validate the predictive model in order to send more accurate commands to the traffic lights.

This application can be configured to produce shorter waiting times at multiple levels based on a subscription, where minimum requirements are guaranteed based on the amount paid. A special version supplied to the emergency vehicles allows giving absolute priority, creating a real green wave in order to substantially reduce the time required for an intervention. The advantages offered by the present invention are clear in the light of the above description and will be even clearer from the accompanying figures and the related detailed description.

### BRIEF DESCRIPTION OF THE DRAWINGS

The invention will hereinafter be described in at least one preferred embodiment thereof by way of non-limiting example with the aid of the accompanying figures, in which:

FIG. 1 shows the communications that take place between the various elements of the invention, in chronological order a user 10 sets departure and destination on a mobile device 100 or on the device 200, on which the application 300 is executed; this sends to the central unit 400 which elaborates the optimal path, sending to the application 300 the path to follow, and the commands to the traffic lights 500 so that the user 10 remains waiting for the shortest possible time, the user in turn will signal his/her passage at the traffic light 500 through the device 200, the traffic light 500 will communicate the successful passage to the central unit 400, which will update the indications on the application 300 and new commands for the traffic lights 500.

FIG. 2 shows a possible embodiment of the device 200, with which it will be possible to interact through a touch screen 210, the device contains a GPS unit 220, a wan communications module 230, a rechargeable battery 240 and a data connection module 260 and calculation units 270 for the operation of the device.

FIG. 3 shows an alternative of the device 200 where this only integrates a GPS sensor 220 and the wan communications module 230, calculation units 270 for the operation of the device, to these a Bluetooth module 250 is added with which it can communicate with the smartphone 100 of user 10 on which the application 300 is executed.

FIG. 4 shows a possible embodiment of the traffic light 500, with the light bulb system 510, the wired or wireless server communication module 520, and the wan module 530 for communications with the device 200.

### DESCRIPTION OF THE PREFERRED EMBODIMENTS

The present invention will now be described purely by way of non-limiting or binding example with the aid of the figures, which illustrate some embodiments relative to the present inventive concept.

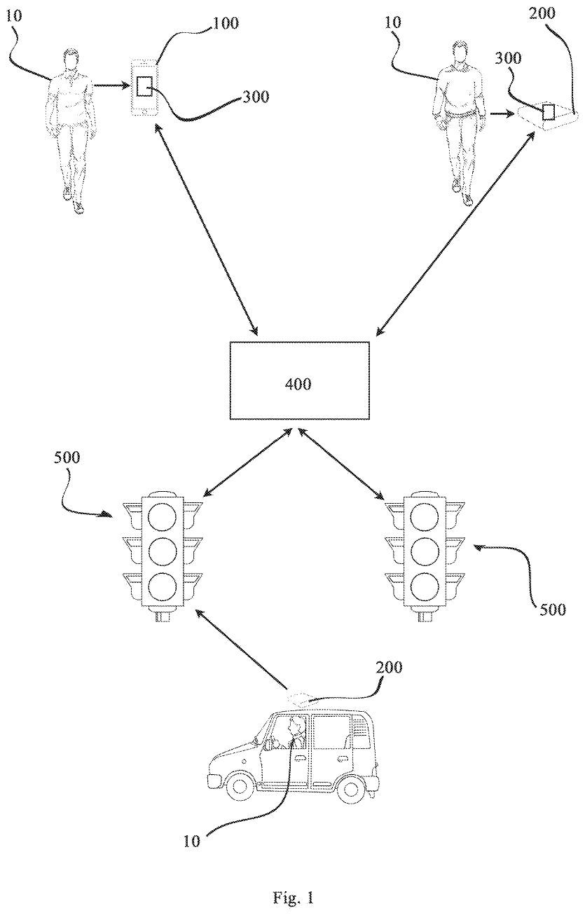

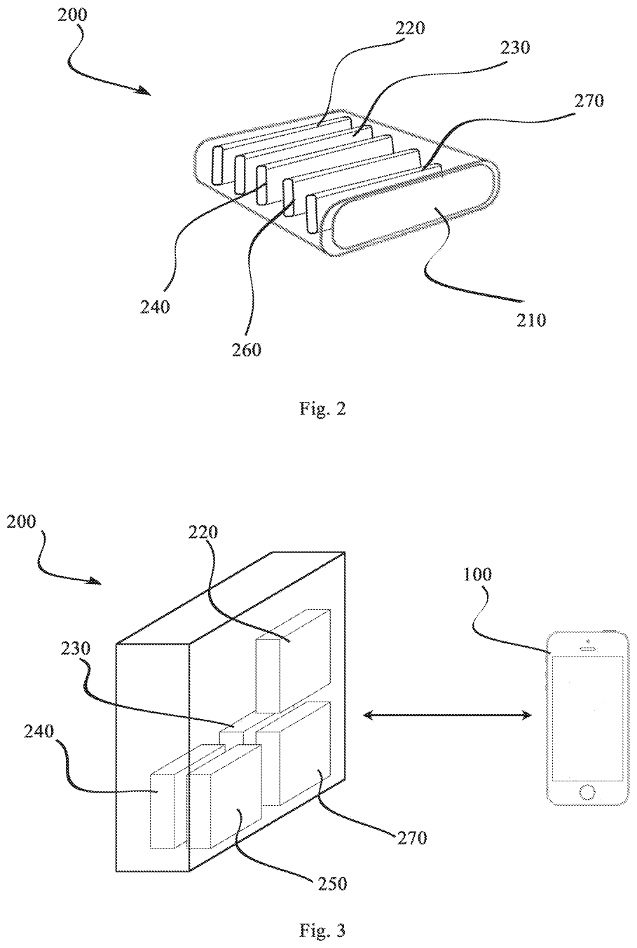

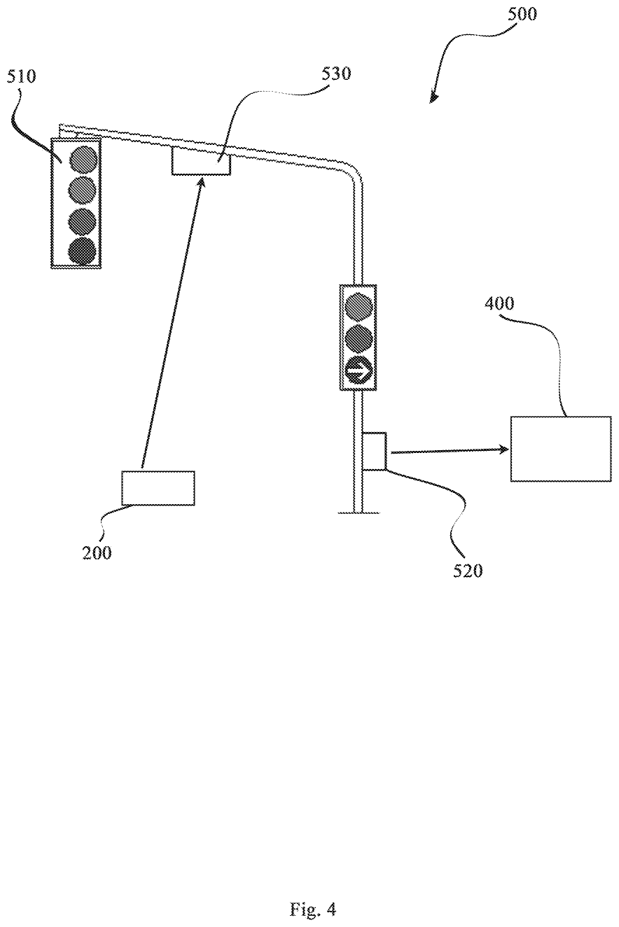

With reference to FIG. 1, a possible embodiment of the adaptive traffic light system is described, aimed at reducing user waiting times and reducing city traffic.

A user 10, who has a subscription to the service, has access to a navigation application 300 which he/she can run on his/her smartphone 100, or on a device 200 if it is set up. This setup occurs with the presence of a touch screen 210 and a GPS unit 220. The device 200 in any case has a rechargeable battery 240, and a wan communications module 230. If the device 200 is not set up, it will communicate with the smartphone 100 of the user 10 via a Bluetooth communication module. It will use the smartphone screen and GPS to ensure the proper functioning of the application 300.

The navigation application 300 allows operation as a typical navigator, however once the departure and destination are entered, it will query the central unit 400 on the best route to follow. The central unit 400 will then provide the route that will avoid dead times, and also optimizes the traffic lights 500 on the route in order to reduce the route time of the user 10. The application also recommends the speed to keep in order to encounter the next traffic light 500 when green.

The device 200 in both its embodiments will be used to signal, through wan communications between the device 200 itself and the traffic lights 500, the passage at the intersection, adding precision to the estimate made via GPS, both of the smartphone 100, and inside of device 220. The traffic lights 500, proposed in this embodiment, are able to operate in a timed manner, turning on the lights 510 like the traffic lights common today, or they can vary the switching intervals, and therefore manage the flow of oncoming vehicles, as established by the central unit 40 which manages the paths of all users 10 who use the application 300. This is made possible by the wireless or wired communications module 520. Communication takes place in both directions. The traffic light 500 in fact receives the intervals to be set in order to stop the users as little as possible. The traffic light 500 sends signals to the central unit 400 is signals confirm the passage of a user at the intersection thanks to the wan communications module 530, which scans the device 200 of the vehicles approaching the intersection.

The central unit 400 allows:
managing the requests coming from the application 300 of the various users 10 registered with the service containing starting and destination point;
providing a path with minimum guarantees on waiting times based on the subscription level of users 10;
providing a preferred path for the emergency vehicles in order to reduce response times in emergency situations;
constructing a predictive model for each vehicle which will simulate the vehicle during its path considering the current traffic;
using the predictive model for calculating the ideal values to send to the traffic lights 500 on the path so that the user 10 finds them green when he/she reaches them, consequently he/she will not have to stop and wait;
updating the predictive model based on the readings coming from the GPS sensor 230 within the device 200 or the smartphone of the user;
updating the predictive model based on the readings coming from the WAN communications module 530 which is activated with the passage of the user 10 due to the device 200;
using the updated predictive model for dynamically managing the commands to send to the traffic lights 500 in order to decrease the wait times of the users registered in the service;

modeling the behavior of users who are not subscribed to the service and considering when calculating the optimal path.

The system is strongly interconnected, this quality and the ability to monitor users along the way allow the system to be precise.

Furthermore, the devices 500 can operate in a fully timed manner when they are not involved in the paths of the users 10.

Traffic lights 500 scan through the wan module 530 the devices 200 inside the vehicles of the users even when they are not using the application 300. This allows you to have updated information on the traffic situation. The calculations made by the central unit take into account a maximum speed that respects the speed limits. Therefore a user 10 will be able to exploit the advantages offered by the invention only if he/she respects the limits. This will also reduce accidents due to high speed. The central unit 400 also allows the storage of data for a long period of time. This will allow for ever more precise models.

Finally, it is clear that modifications, additions or variants may be made to the invention described thus far which are obvious to a man skilled in the art, without departing from the scope of protection that is provided by the appended claims.

1. Adaptive traffic light system for reducing traffic, composed of different interconnected modules; a module being constituted by an application executable on a smartphone, or on an ad-hoc hardware device; said mobile application carrying out the functions of a navigator; said application indicating the recommended instantaneous speed; said application sending the point of arrival and departure to a central unit; said central unit will calculate the best path in terms of time, length, traffic and with the lowest wait time at the traffic light devices; said central unit providing a path with minimum guarantees according to the membership subscribed by the user; said central unit providing preferred lane for emergency vehicles; said central unit sending the commands to the traffic light devices so that they minimize the user travel time; said traffic lights receiving the commands through the wireless or wired communication module; said traffic lights being green in conjunction with the arrival of the user, or if this is not possible, making the user wait the least possible time at the traffic light; said traffic lights functioning in a timed manner when not involved in the path of a user; said path providing guarantees only if the user respects the speed limits; said device communicating with the traffic lights the occurred passage at the intersection; said communication occurring by means of WAN protocol installed in the device through the WAN module and on the traffic light with the WAN module; the occurred passage being communicated by the traffic light with the wireless or wired communications module to the central unit; said device being used for signaling the presence at the traffic light; said device communicating with the smartphone of the user on which the application is executed by means of Bluetooth protocol; said application sending the data relative to the actual position and speed to the central unit; such data, together with that sent by the traffic lights, being used for updating the information on the path of the user by the central unit; such updates being used for recalculating the commands to send to the traffic lights.

2. Adaptive traffic light system for reducing traffic, according to claim 1, wherein said device can have two embodiments; said device signaling the transit that occurred at the intersection where traffic light is positioned:
being arranged for executing the application; said device being provided with a touch screen and a GPS unit; said device functioning as navigator; said device having rechargeable battery; said device comprising a WAN communications module; said device being able to communicate with the central unit through the application due to the data connection module; said device using a calculation unit for the operation thereof;
not being arranged for executing the application; said device being provided with a Bluetooth module for communicating with the smartphone of the user, on which the application is executed; screen, GPS and data connection of the smartphone will be used for interacting with the application and communicating with the central unit; said device being provided with rechargeable battery; said device comprising a WAN communications module; said device using a calculation unit for the operation thereof.

3. Adaptive traffic light system for reducing traffic, according to claim 1, wherein said traffic lights are able to function in a timed manner, turning on the lights like common traffic light devices; said traffic lights being able to vary the turning-on intervals of the lights system, managing the flow of arriving vehicles; said variations being calculated and sent by the central unit; said variations being received by said traffic lights through the wireless or wired communications module; said traffic lights using said module for signaling the occurred passage of a user at the intersection; said passage being detected by the WAN module which communicates with the WAN module of the device of the user.

4. Adaptive traffic light system for reducing traffic, according to claim 1, wherein said central unit allows:
managing the requests coming from the application of the various users registered with the service containing starting and destination point;
providing a path with minimum guarantees on the wait times based on the membership level of the users; said level translating into time savings, lower wait time at red lights, greater probability of green lights;
providing a preferred path for the emergency vehicles in order to reduce response times in emergency situations;
constructing a predictive model for each vehicle of each user which will simulate the vehicle during its path considering the current traffic;
using the predictive model for calculating the ideal values to send to the traffic lights on the path so that the user finds them green when he/she reaches them, consequently avoiding stopping;
updating the predictive model based on the readings coming from the GPS sensor within the device or the smartphone of the user;
updating the predictive model based on the readings coming from the WAN communications module installed within the traffic light devices, which is activated with the passage of the user due to the device;
using the updated predictive model for dynamically managing the commands to send to the traffic lights in order to decrease the wait times of the users registered in the service.

5. Adaptive traffic light system for reducing traffic, according to claim 1, wherein said central unit can model the current traffic by using the devices of the users; said central unit can model the present traffic by using the devices of the users who do not use the application; said central unit storing the data relative to the traffic in order to have an updated and precise model.

6. Adaptive traffic light system for reducing traffic, according to claim 1, wherein said central unit can model the daily paths of the users, storing the data relative to the information inserted in the application with regard to the starting places and destinations; by means of said application it will be possible to establish a path that will be repeated each requested day of the week, at the pre-established hour, being able to use the invention during the home-work routes.

7. Adaptive traffic light system for reducing traffic, according to claim 1, wherein the application can be executed within the computer on board of cars.

8. Adaptive traffic light system for reducing traffic, according to claim 1, wherein the device can be integrated within the automobile; such device able to be integrated within the automobile, being used by means of the application executed on the computer on board the vehicle.

9. Adaptive traffic light system for reducing traffic, according to claim 1, wherein the advantages offered by the invention can be uniquely exploited by the users who respect the speed limits; said central unit using as maximum speed in the predictive model that of the current limit on the path; said central unit sending to the application the recommended instantaneous speed; said application showing the instantaneous speed that the user must have in order to fully exploit the advantages offered by the application; said application notifying the user regarding the discrepancy of the speed maintained by the user and that recommended; said characteristic discouraging high speed on the road.

10. Adaptive traffic light system for reducing traffic, according to claim 1, wherein the emergency vehicle have maximum priority in the calculations carried out by the central unit; said calculations resulting in a green wave that such vehicles encounter during their path; said calculations resulting a smaller line of cars at the traffic light upon arrival of the emergency vehicle; said characteristic reducing the intervention times.

11. Adaptive traffic light system for reducing traffic, according to claim 2, wherein said traffic lights are able to function in a timed manner, turning on the lights like common traffic light devices; said traffic lights being able to vary the turning-on intervals of the lights system, managing the flow of arriving vehicles; said variations being calculated and sent by the central unit; said variations being received by said traffic lights through the wireless or wired communications module; said traffic lights using said module for signaling the occurred passage of a user at the intersection; said passage being detected by the WAN module which communicates with the WAN module of the device of the user.

12. Adaptive traffic light system for reducing traffic, according to claim 2, wherein said central unit allows:
managing the requests coming from the application of the various users registered with the service containing starting and destination point;
providing a path with minimum guarantees on the wait times based on the membership level of the users; said level translating into time savings, lower wait time at red lights, greater probability of green lights;
providing a preferred path for the emergency vehicles in order to reduce response times in emergency situations;
constructing a predictive model for each vehicle of each user which will simulate the vehicle during its path considering the current traffic;
using the predictive model for calculating the ideal values to send to the traffic lights on the path so that the user finds them green when he/she reaches them, consequently avoiding stopping;
updating the predictive model based on the readings coming from the GPS sensor within the device or the smartphone of the user;
updating the predictive model based on the readings coming from the WAN communications module installed within the traffic light devices, which is activated with the passage of the user due to the device;
using the updated predictive model for dynamically managing the commands to send to the traffic lights in order to decrease the wait times of the users registered in the service.

13. Adaptive traffic light system for reducing traffic, according to claim 3, wherein said central unit allows:
managing the requests coming from the application of the various users registered with the service containing starting and destination point;
providing a path with minimum guarantees on the wait times based on the membership level of the users; said level translating into time savings, lower wait time at red lights, greater probability of green lights;
providing a preferred path for the emergency vehicles in order to reduce response times in emergency situations;
constructing a predictive model for each vehicle of each user which will simulate the vehicle during its path considering the current traffic;
using the predictive model for calculating the ideal values to send to the traffic lights on the path so that the user finds them green when he/she reaches them, consequently avoiding stopping;
updating the predictive model based on the readings coming from the GPS sensor within the device or the smartphone of the user;
updating the predictive model based on the readings coming from the WAN communications module installed within the traffic light devices, which is activated with the passage of the user due to the device;
using the updated predictive model for dynamically managing the commands to send to the traffic lights in order to decrease the wait times of the users registered in the service.

14. Adaptive traffic light system for reducing traffic, according to claim 2, wherein said central unit can model the current traffic by using the devices of the users; said central unit can model the present traffic by using the devices of the users who do not use the application; said central unit storing the data relative to the traffic in order to have an updated and precise model.

15. Adaptive traffic light system for reducing traffic, according to claim 3, wherein said central unit can model the current traffic by using the devices of the users; said central unit can model the present traffic by using the devices of the users who do not use the application; said central unit storing the data relative to the traffic in order to have an updated and precise model.

16. Adaptive traffic light system for reducing traffic, according to claim 4, wherein said central unit can model the current traffic by using the devices of the users; said central unit can model the present traffic by using the devices of the users who do not use the application; said central unit storing the data relative to the traffic in order to have an updated and precise model.

17. Adaptive traffic light system for reducing traffic, according to claim 2, wherein said central unit can model the daily paths of the users, storing the data relative to the information inserted in the application with regard to the starting places and destinations; by means of said application it will be possible to establish a path that will be repeated each requested day of the week, at the pre-established hour, being able to use the invention during the home-work routes.

18. Adaptive traffic light system for reducing traffic, according to claim 3, wherein said central unit can model the daily paths of the users, storing the data relative to the information inserted in the application with regard to the starting places and destinations; by means of said application it will be possible to establish a path that will be repeated each requested day of the week, at the pre-established hour, being able to use the invention during the home-work routes.

19. Adaptive traffic light system for reducing traffic, according to claim 4, wherein said central unit can model the daily paths of the users, storing the data relative to the information inserted in the application with regard to the starting places and destinations; by means of said application it will be possible to establish a path that will be repeated each requested day of the week, at the pre-established hour, being able to use the invention during the home-work routes.

20. Adaptive traffic light system for reducing traffic, according to claim 5, wherein said central unit can model the daily paths of the users, storing the data relative to the information inserted in the application with regard to the starting places and destinations; by means of said application it will be possible to establish a path that will be repeated each requested day of the week, at the pre-established hour, being able to use the invention during the home-work routes.
